(19) United States
(12) Patent Application Publication
(10) Pub. No.: US 2026/0260477 A1
(43) Pub. Date: Sep. 3, 2026

(54) PEDESTRIAN DETECTION METHOD FOR AUTONOMOUS DRIVING UNDER COMPLEX BACKGROUNDS

(71) Applicants: East China Jiaotong University, Nanchang (CN); Institute for Smart City of Chongqing University In Liyang, Changzhou (CN); Hangzhou Institute Of Communications Planning Design&research Co., Ltd., Hangzhou (CN)

(72) Inventors: Xiangyu Wang, Perth (AU); Junbo Sun, Changzhou (CN); Hongyu Zhao, Nanchang (CN); Kan Gu, Hangzhou (CN); Jun Wang, Nanchang (CN)

(21) Appl. No.: 19/654,813

(22) Filed: Apr. 22, 2026

(30) Foreign Application Priority Data
Apr. 23, 2025 (CN) 202510513195.8

(51) Int. Cl. G06V 10/82; B60W 40/04; B60W 60/00; G06V 10/77; G06V 10/774; G06V 20/58; G06V 40/10

(52) U.S. Cl. CPC G06V 10/82; G06V 10/7715; G06V 10/774; G06V 20/58; G06V 40/10; B60W 40/04; B60W 60/001; B60W 2420/403; B60W 2420/408; B60W 2554/4029; B60W 2554/802

(57) ABSTRACT

Provided are a pedestrian detection method and system for autonomous driving under complex backgrounds. The detection method includes: acquiring a dataset including pedestrian images under different backgrounds and different degrees of occlusion; constructing an Automatic Driving You Only Look Once Respond for Pedestrian Background Influence Object Detection Network (AD-YOLO-RPBNet) model, where a backbone part includes four serial structures including convolution blocks and diverse branch C3K2 modules; in a neck part of the AD-YOLO-RPBNet model, one diverse branch C3K2 module is introduced in a first column, three alternating diverse branch C3K2 modules are introduced in a second column, and an output of each diverse branch C3K2 module in the second column is connected to a detection head via a diverse efficient local attention (DELA) module; and training the model by using the obtained dataset, where the trained model is used for pedestrian detection of autonomous driving under complex backgrounds.

### CROSS-REFERENCE TO RELATED APPLICATIONS

This patent application claims the benefit and priority of Chinese Patent Application No. 2025105131958 filed with the China National Intellectual Property Administration on Apr. 23, 2025, the disclosure of which is incorporated by reference herein in its entirety as part of the present application.

### TECHNICAL FIELD

The present disclosure relates to the technical field of vehicle target detection and processing, and in particular, to a pedestrian detection method and system for autonomous driving under complex backgrounds.

### BACKGROUND

In the technical field of vehicle target detection and processing, accurately identifying and localizing pedestrian targets is crucial for autonomous driving, intelligent transportation systems, and other applications. Pedestrian detection is one of the key technologies in autonomous driving and is of great significance for achieving highly automated driving. In autonomous driving systems, recognizing road conditions through precise target detection to enable safe driving of autonomous vehicles is a critical task. Especially after detecting pedestrians on the road, the system needs to make fast and accurate decisions based on real-time traffic conditions, thereby achieving automatic obstacle avoidance of autonomous vehicles by automatically controlling vehicle speed and braking.

Traditional pedestrian target detection methods mainly rely on manually designed feature extractors and classifiers. These methods can achieve certain results under specific conditions, but often perform poorly when dealing with complex scenarios. For example, traditional methods based on features such as edge detection tend to fail in dynamic scenarios and complex backgrounds, leading to inaccurate feature extraction and thus affecting detection performance.

With the development of deep learning technology, pedestrian target detection methods based on convolutional neural networks (CNNs) and the You Only Look Once (YOLO) series of network models have received widespread attention due to powerful feature learning capabilities. These methods can automatically learn features from images and have certain adaptability to dynamic and complex scenarios. However, existing methods are susceptible to interference in pedestrian detection algorithms when backgrounds contain numerous cluttered objects or textures, or when pedestrians have similar colors or textures to the background, leading to false detections or missed detections. Moreover, moving objects in the background cause instability in the background model, and these objects may be falsely detected as pedestrians, affecting the accuracy and robustness of target detection.

Therefore, developing a pedestrian detection method and system for autonomous driving that can effectively cope with the influence of complex backgrounds, enabling high-precision pedestrian target detection under complex backgrounds during autonomous vehicle travel, achieving effective pedestrian recognition in autonomous driving, and thus accurately identifying pedestrian targets for automatic vehicle obstacle avoidance, has important practical significance and application value.

### SUMMARY

In view of the deficiencies of the prior art, the present disclosure aims to provide a pedestrian detection method and system for autonomous driving under complex backgrounds, to resolve the above-mentioned significant defects existing in the prior art. The method can maintain high accuracy and robustness under various complex backgrounds, while possessing a real-time processing capability, thereby meeting the requirements of autonomous driving for pedestrian recognition and automatic obstacle avoidance, and improving the performance of pedestrian target detection in complex backgrounds.

To resolve the above technical problems, the technical solution adopted in the present disclosure is as follows:

According to a first aspect, the present disclosure provides a pedestrian detection method for autonomous driving under complex backgrounds, including following steps:
step 1: obtaining a dataset, where
a binocular vehicle-mounted camera is used to capture pedestrian images under actual road conditions in shopping malls, stations, and different streets at different time periods, pedestrian images under different urban backgrounds and different degrees of occlusion are acquired from the Internet, including images with simple backgrounds and complex backgrounds under different degrees of occlusion, and the pedestrian images together form the dataset; images in the dataset are annotated using LabelImg, to mark pedestrian targets in the images, including position boxes and category information of pedestrians;
step 2: constructing an Automatic Driving You Only Look Once Respond for Pedestrian Background Influence Object Detection Network (AD-YOLO-RPBNet) model, where
a backbone part of the AD-YOLO-RPBNet model includes four serial structures including convolution blocks and diverse branch C3K2 modules; and in a neck part of the AD-YOLO-RPBNet model, one diverse branch C3K2 module is introduced in a first column, three alternating diverse branch C3K2 modules are introduced in a second column, and an output of each diverse branch C3K2 module in the second column is connected to a detection head via a diverse efficient local attention (DELA) module;
the diverse branch C3K2 module includes a convolution block, from which two branches diverge, and one branch is processed by two diverse branch C3K modules, and then concatenated with the other branch, followed by a 1×1 convolution to generate an output;
the diverse branch C3K module includes a convolution block and two bottleneck layers that are sequentially connected; and each bottleneck layer includes two diverse branch convolutions connected in sequence;
each diverse branch convolution includes five branches, where a first branch outputs after a 1×1 convolution and a batch normalization (BN) layer; a second branch outputs after a 1×1 convolution, a BN layer, a 3×3 convolution, and a BN layer in sequence; a third branch outputs after a 1×1 convolution, a BN layer, a max pooling layer, and a BN layer in sequence; a fourth branch outputs after a 3×3 convolution, a BN layer, an average pooling layer, and a BN layer in sequence; a fifth branch outputs after a 3×3 convolution and a BN layer; and finally, outputs of the five branches are concatenated and then processed by a non-linear layer to obtain an output of the diverse branch convolution;
the DELA module is provided with three branches, where two branches respectively use X max pooling and Y average pooling in a spatial dimension to obtain feature vectors in horizontal and vertical directions, the feature vectors respectively pass through a 1×1 convolution, a group normalization (GN) layer, and a sigmoid function to generate attention weights in the horizontal and vertical directions, and feature weighting is performed on the attention weights in the horizontal and vertical directions and an input of the DELA module according to corresponding directions, to obtain an output of the DELA module; and step 3: training the AD-YOLO-RPBNet model using the dataset obtained in the step 1, where the trained AD-YOLO-RPBNet model is used for pedestrian detection of autonomous driving under complex backgrounds.

Further, the neck part of the AD-YOLO-RPBNet model includes three columns of structures, where the first column is formed by connecting in sequence from bottom to top an upsampling operation, a concatenation operation, a diverse branch C3K2 module, an upsampling operation, and a concatenation operation; the second column is formed by connecting in sequence from top to bottom a diverse branch C3K2 module, a convolution block, a concatenation operation, a diverse branch C3K2 module, a convolution block, a concatenation operation, and a diverse branch C3K2 module; and the third column includes three parallel DELA modules;
an output of a cross stage partial with pyramid squeeze attention (C2PSA) module in the backbone part is connected to the upsampling operation at the bottom of the first column of the neck part and the concatenation operation at the bottom of the second column; outputs of a third diverse branch C3K2 module and a second diverse branch C3K2 module in the backbone part are respectively connected to the two concatenation operations in the first column of the neck part; an output of the diverse branch C3K2 module in the first column of the neck part is connected to the concatenation operation at the top of the second column; an output of the concatenation operation at the top of the first column is input into the diverse branch C3K2 module at the top of the second column; and the three diverse branch C3K2 modules in the second column are each connected to one DELA module; and
in an output part of the AD-YOLO-RPBNet model, three feature maps of different scales are processed by three detection heads, so as to recognize pedestrian targets of different sizes in an image, and display category information and bounding boxes of the pedestrian targets detected in the image.

Further, the AD-YOLO-RPBNet model uses an occlusion-weighted focal loss LOWFL that considers occlusion category weights, as a loss constraint during training.

Further, at the start of training, model initialization parameters are set as follows: a number of epochs for model training is set to 650, an optimizer adopts an adaptive gradient descent (Adagrad) optimizer, an initial learning rate of the Adagrad optimizer is set to 0.01, and a gradient weight decay parameter is set to 5e-2; and training is stopped when a loss variation error is within ±1e-4.

Further, a size of the images in the dataset is 640×640.

According to a second aspect, the present disclosure provides a pedestrian detection system for autonomous driving under complex backgrounds, executing the steps of the pedestrian detection method for autonomous driving under complex backgrounds, and including:
a binocular vehicle-mounted camera module configured to acquire pedestrian images under different road conditions;
an Automatic Driving You Only Look Once Respond for Pedestrian Background Influence Object Detection Network (AD-YOLO-RPBNet) model configured to perform real-time pedestrian target detection during autonomous driving;
a vehicle-pedestrian distance calculation module configured to measure a distance and angle between and speed of a vehicle and a target using a millimeter-wave radar sensor based on a target detection result; and
a feedback module configured to alert a driver based on a calculation result of the vehicle-pedestrian distance calculation module and to adjust a driving state of the vehicle.

Further, the target detection result, the distance between the vehicle and the target, and a relative position of the target to the vehicle are displayed on a vehicle-mounted screen, where the target detection result includes confidence and a degree of occlusion; and
the feedback module is triggered based on the target detection result and data from the vehicle-pedestrian distance calculation module, to determine a hierarchical announcement level according to the calculation result of the vehicle-pedestrian distance calculation module, and issue a hierarchical announcement of a “watch for pedestrians” instruction, a “slow down” instruction, or an “emergency brake” instruction.

Further, the AD-YOLO-RPBNet model is applied to pedestrian target detection in autonomous driving under complex backgrounds, achieving mean average precision (mAP) greater than 70%, frames per second (FPS) greater than 80, and a parameter count between 15 and 20 million. Preferably, the mAP is greater than 75%, and the FPS is greater than 90.

Compared with the prior art, beneficial effects of the present disclosure are as follows:

The present disclosure proposes, in response to the influence of complex backgrounds, the Automatic Driving YOLO Respond for Pedestrian Background Influence Object Detection Network model, referred to as the AD-YOLO-RPBNet model, which demonstrates significant advantages in a plurality of aspects:

In the model of the present disclosure, the diverse branch C3K2 module is used multiple times, and three DELA modules are introduced before the three detection heads, significantly improving the performance and accuracy of pedestrian target detection. In the DELA module, different pooling methods are used for the X (horizontal) and Y (vertical) directions, enabling the model to focus more on pedestrian target regions in the images while effectively suppressing interference from irrelevant background information, thereby reducing the impact of background noise on pedestrian target detection, enhancing the model adaptability to different scenarios, lighting conditions, and shooting angles, and improving detection robustness. Further, the rational placement of the DELA modules not only greatly improves detection accuracy and speed, but also enhances the generalization ability and environmental adaptability of the model. This provides an efficient and robust solution for pedestrian target detection, helps reduce false detections, and performs particularly well for small-sized or low-contrast targets. Importantly, these improvements are achieved without significantly increasing the computational burden, ensuring that the speed of pedestrian target detection remains unaffected.

In terms of the loss function, the present disclosure proposes an occlusion-weighted focal loss to address the pedestrian occlusion problem. By assigning different occlusion category weights (for example, ωc=2.0 for heavy occlusion) to different degrees of occlusion, the model is forced to pay more attention to the feature learning of occluded samples during training, thereby balancing the contributions of occluded samples and normal samples. This specifically addresses the pedestrian occlusion problem under complex backgrounds, achieving a balance among accuracy, robustness, and efficiency.

The AD-YOLO-RPBNet model of the present disclosure can respond to the influence of complex backgrounds in real time and automatically detect the positions of pedestrians in front of an autonomous vehicle. After detecting pedestrians, the AD-YOLO-RPBNet model can provide accurate vehicle-pedestrian distance calculations for the autonomous vehicle, and issue warnings and adjust driving decisions based on the relative position between the vehicle and the target and the vehicle-pedestrian distance. This ensures driving safety and efficiency under various complex backgrounds, enables effective obstacle avoidance, and further optimizes driving efficiency.

The present disclosure accomplishes the task of pedestrian target detection under complex backgrounds. By incorporating the Internet of Vehicles technology, the system enables autonomous vehicles to make optimal and safe autonomous driving decisions in complex urban environments.

In summary, the AD-YOLO-RPBNet model of the present disclosure enriches the scale of feature extraction and improves the ability to capture important features during pedestrian target detection under complex backgrounds. While reducing computational load, the model achieves deeper pyramidal feature fusion and extraction, enabling it to better handle pedestrian target detection tasks in complex backgrounds. This not only improves target detection accuracy but also realizes a lightweight design, enhancing the applicability in autonomous vehicles by balancing detection accuracy, computational efficiency, and parameter minimization. The model can operate efficiently even on resource-constrained devices, demonstrating excellent performance in the field of autonomous driving target detection and holding broad application prospects.

### BRIEF DESCRIPTION OF THE DRAWINGS

FIG. 1 is a schematic structural diagram of an AD-YOLO-RPBNet model according to an embodiment of the present disclosure;

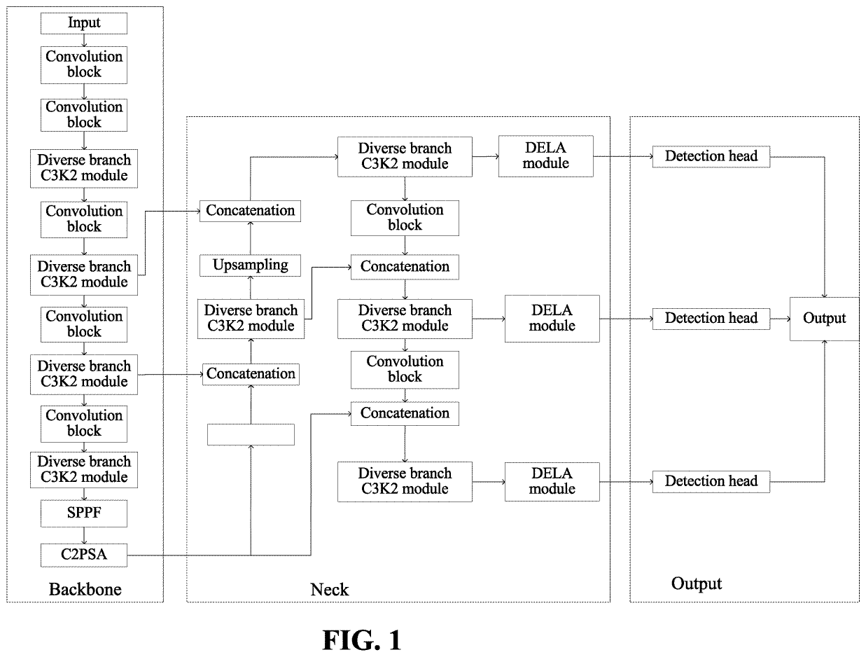

FIG. 2 is a schematic structural diagram of a diverse branch C3K2 module according to an embodiment of the present disclosure; and

FIG. 3 is a schematic structural diagram of a DELA module according to an embodiment of the present disclosure.

### DETAILED DESCRIPTION OF THE EMBODIMENTS

In order to describe the technical problems, technical solutions, and advantages of the present disclosure more clearly, a detailed description is given below with reference to the accompanying drawings and embodiments. It should be noted that the embodiments are merely for illustrating the principles and scope of application of the present disclosure and should not be construed as limiting the present disclosure.

In the description of the present disclosure, the specific features, structures, or features described may be combined in a suitable manner in any one or more embodiments or examples.

### Embodiment 1

This embodiment provides a pedestrian detection method for autonomous driving under complex backgrounds, including the following steps:

In step 1, a dataset is obtained.

A binocular vehicle-mounted camera is used to capture pedestrian images under actual road conditions in shopping malls, stations, and different streets at different time periods, pedestrian images under different urban backgrounds and different degrees of occlusion are acquired from the Internet, including images with simple backgrounds and complex backgrounds under different degrees of occlusion, and the pedestrian images together form the dataset; images in the dataset are annotated using LabelImg, to mark pedestrian targets in the images, including position boxes and category information of pedestrians.

Occluded pedestrians are classified into three categories:
Light occlusion: The pedestrian occlusion ratio is less than or equal to 30%. Key body parts are visible. The head, shoulders, torso, and the like are basically visible. Occlusion only affects local areas and does not affect overall shape recognition. For example, a pedestrian stands behind a street sign, and a metal pole occludes the waist; a pedestrian pushes a cart and the handlebar occludes the right forearm; or a tree branch occludes about 20% of the left shoulder of the pedestrian in a park.
Moderate occlusion: The pedestrian occlusion ratio is greater than 30% and less than or equal to 60%. Major body structures, such as limbs and torso of the pedestrian are partially missing, but logical inference can be made from the remaining limbs or context. For example, two pedestrians walking side by side, and the chest and abdomen of the rear pedestrian are occluded by the front pedestrian; or a pedestrian crosses the road and the front of a car occludes the area from the waist to the thighs.
Heavy occlusion: The pedestrian occlusion ratio is greater than 60%, leaving only fragmented body features, making it difficult even for the naked eye to quickly identify. For example, a truck side completely occludes the pedestrian, leaving only the tip of the left shoe and a corner of the right elbow clothing; or a pedestrian holds an umbrella in heavy rain, exposing only the lower half of the calves and sports shoes.

In step 2: an AD-YOLO-RPBNet model is constructed.

The AD-YOLO-RPBNet model includes three parts: backbone, neck, and output.

The backbone part, from top to bottom, includes a head formed by a convolution block with a kernel size of 2, an intermediate unit, and a tail formed by a Spatial Pyramid Pooling-Fast (SPPF) module and a C2PSA module connected in series. The intermediate unit includes four serial structures including convolution blocks and diverse branch C3K2 modules.

The neck part includes three columns of structures. The first column is formed by connecting in sequence from bottom to top an upsampling operation, a concatenation operation, a diverse branch C3K2 module, an upsampling operation, and a concatenation operation. The second column is formed by connecting in sequence from top to bottom a diverse branch C3K2 module, a convolution block, a concatenation operation, a diverse branch C3K2 module, a convolution block, a concatenation operation, and a diverse branch C3K2 module. The third column includes three parallel DELA modules.

An output of a C2PSA module in the backbone part is connected to the upsampling operation at the bottom of the first column of the neck part and the concatenation operation at the bottom of the second column; outputs of a third diverse branch C3K2 module and a second diverse branch C3K2 module in the backbone part are respectively connected to the two concatenation operations in the first column of the neck part; an output of the diverse branch C3K2 module in the first column of the neck part is connected to the concatenation operation at the top of the second column; an output of the concatenation operation at the top of the first column is input into the diverse branch C3K2 module at the top of the second column; and the three diverse branch C3K2 modules in the second column are each connected to one DELA module.

In an output part, outputs of the three DELA modules in the third column of the neck part are respectively processed by three detection heads on three feature maps of different scales, so as to recognize pedestrian targets of different sizes in an image, and display category information and bounding boxes of the pedestrian targets detected in the image.

The diverse branch C3K2 module includes a convolution block, from which two branches diverge, and one branch is processed by two diverse branch C3K modules, and then concatenated with the other branch, followed by a 1×1 convolution to generate an output.

The diverse branch C3K module includes a main path formed by a convolution block and two bottleneck layers connected in sequence. Outputs of the convolution block and the two bottleneck layers serve as three branches. The three branches are concatenated with an output of the main path, followed by a 1×1 convolution to obtain an output of the diverse branch C3K module.

The bottleneck layer includes two diverse branch convolutions connected in sequence. Outputs of the two diverse branch convolutions are concatenated with an input to obtain an output of the bottleneck layer.

Each diverse branch convolution includes five branches: a first branch outputs after a 1×1 convolution and a BN layer; a second branch outputs after a 1×1 convolution, a BN layer, a 3×3 convolution, and a BN layer in sequence; a third branch outputs after a 1×1 convolution, a BN layer, a max pooling layer, and a BN layer in sequence; a fourth branch outputs after a 3×3 convolution, a BN layer, an average pooling layer, and a BN layer in sequence; a fifth branch outputs after a 3×3 convolution and a BN layer; and finally, outputs of the five branches are concatenated and then processed by a non-linear layer to obtain an output of the diverse branch convolution.

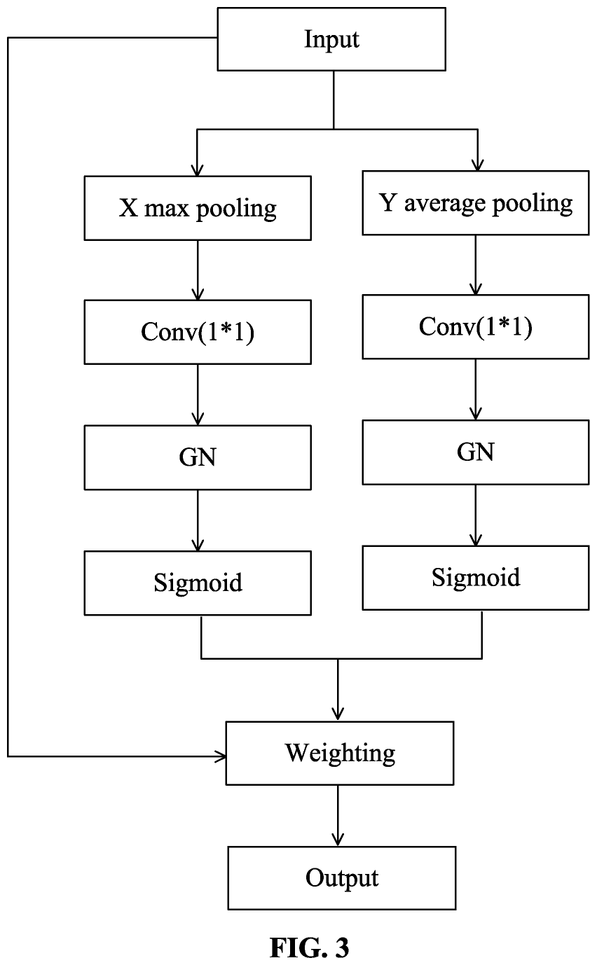

The DELA module (referred to FIG. 3) is provided with three branches, where two branches respectively use X max pooling and Y average pooling in a spatial dimension to obtain feature vectors in horizontal and vertical directions, the feature vectors respectively pass through a 1×1 convolution, a GN layer, and a sigmoid function to generate attention weights in the horizontal and vertical directions, and feature weighting is performed on the attention weights in the horizontal and vertical directions and an input of the DELA module according to corresponding directions, to obtain an output of the DELA module.

Thus, the construction of the AD-YOLO-RPBNet model is completed.

In step 3, the AD-YOLO-RPBNet model is trained using the dataset obtained in the step 1. The trained AD-YOLO-RPBNet model is used for pedestrian detection of autonomous driving under complex backgrounds.

In step 3, the occlusion-weighted focal loss LOWFL is used as a loss constraint during training. The occlusion-weighted focal loss LOWFL is expressed as:

$${L}_{OWFL} = - {\sum }_{i = 1}^{N} {\sum }_{c = 1}^{C} {ω}_{c} \cdot α \cdot {( 1 - {p}_{i c} )}^{γ} \cdot {y}_{i c} \cdot log ( {p}_{i c} )$$

N is the number of samples and C is the number of categories. y_{ic} is a ground-truth label of an i^{th} sample belonging to a category c (one-hot encoding, where only one element is 1 and the rest are 0). p_{ic} is a prediction probability that the i^{th} sample belongs to the category c. ωc is an occlusion category weight. Categories without occlusion, background interference, or overly dense pedestrians are all considered as light occlusion, with occlusion category ωc=1.0; for light occlusion images, ωc=1.0; for moderate occlusion images, ωc=1.5; and for heavy occlusion images, ωc=2.0. α is a balancing factor used to adjust the weight between positive and negative samples, with a default value of α=2.0. γ is a focusing parameter used to control the degree of attention to hard samples, with a default value of γ=4.0.

### Embodiment 2

This embodiment provides a pedestrian detection method for autonomous driving under complex backgrounds, using an AD-YOLO-RPBNet model, and including the following steps:

In step 1, a dataset is obtained.

A binocular vehicle-mounted camera is used to capture images in different urban scenarios with dense pedestrians, such as urban streets, shopping malls, stations, and areas near schools. Actual road condition images are captured on a plurality of streets at different time periods to obtain actual conditions of different streets, including images with simple backgrounds and complex backgrounds under different degrees of occlusion. The images under simple and complex backgrounds are then classified into light, moderate, and heavy occlusion images according to the degree of pedestrian occlusion. In addition, besides images with different degrees of occlusion, the images with complex backgrounds also include background interference images and images with overly dense pedestrians, and both images are considered unoccluded. In this embodiment, the dataset includes a total of 12,000 images. There are 4,000 pedestrian images with simple backgrounds, including 1,000 light occlusion images, 1,500 moderate occlusion images, and 1,500 heavy occlusion images. There are 8,000 pedestrian images with complex backgrounds, including 2,000 light occlusion images, 2,000 moderate occlusion images, 2,000 heavy occlusion images, 1,000 background interference images, and 1,000 images with overly dense pedestrians. The images in the obtained dataset are annotated using LabelImg to mark pedestrian targets in the images, including the positions, size, and category information of the pedestrians. The image dataset is randomly divided into a training set and a test set at a ratio of 7:3. To ensure consistent image size when input into the network model, all images are set to 640×640.

In step 2, the AD-YOLO-RPBNet model is constructed, including three parts: backbone, neck, and output.

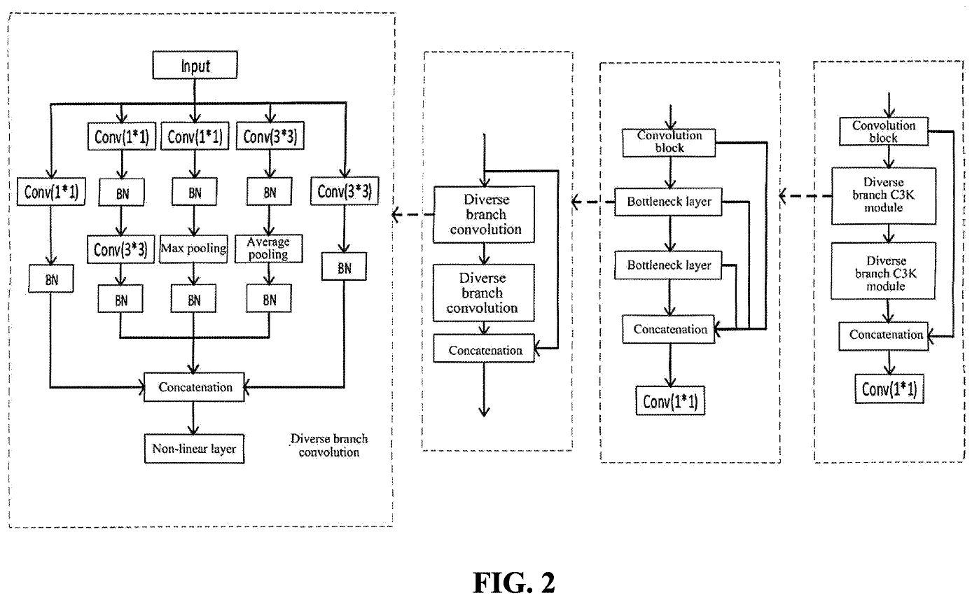

The backbone part, from top to bottom, includes a head, an intermediate unit, and a tail formed by an SPPF module and a C2PSA module connected in series. The intermediate unit includes four serial structures including convolution blocks and diverse branch C3K2 modules. Each convolution block includes a two-dimensional convolution, a two-dimensional BN layer, and a Sigmoid Linear Unit (SiLU) activation function connected in series. The structure of the diverse branch C3K2 module is shown in FIG. 2.

An input image first undergoes processing by the backbone part. The convolution block with a kernel size of 2 in the head of the backbone part performs initial feature extraction and expands the number of channels, converting the input image of size 640×640×3 (height, width, channels) into an initial feature map F₀ of size 320×320×16. Next, the image sequentially passes through the intermediate unit of the backbone part. The first serial structure including a convolution block and a diverse branch C3K2 module performs deep feature extraction on the initial feature map, to output a feature map of F₁ size 160×160×32. Then, the second serial structure performs feature extraction again on the feature map F₁ to obtain a feature map F₂ of size 80×80×64. Next, the third serial structure performs the same feature extraction operation on the feature map F₂ to obtain a feature map F₃ of size 40×40×128. The last serial structure performs feature extraction on the feature map F₃ to obtain a feature map F₄ of size 20×20×256. The SPPF module then performs spatial pyramid pooling on the feature map F₄, and a pooling result is processed by the C2PSA module to obtain a feature map F₅ of size 20×20×256 containing multi-scale information, and F₅ serves as part of the input for the next stage.

The neck part includes two columns with opposite input-output orders and one column of DELA modules. The first column takes the feature map F₅ as input, which passes through an upsampling operation to obtain a feature map F_{A1} of size 40×40×256, and then the feature map F_{A1} is concatenated with the feature map F₃, to obtain a feature map F_{A2} of size 40×40×384. Then, the feature map F_{A2} is used as input, passes through a diverse branch C3K2 module for feature extraction to obtain a feature map F_{A3} of size 40×40×128, which after one upsampling operation, is concatenated with the feature map F₂ to obtain a feature map F_{A4} of size 80×80×192. The second column takes the feature map F_{A4} as input, which passes through a diverse branch C3K2 module for feature extraction to obtain a feature map F_{B1} of size 80×80×64. Then, the feature map F_{B1} passes through a convolution block for feature extraction to obtain a feature map F_{B2} of size 40×40×64. The feature map F_{B2} is concatenated with the feature map F_{A3} to obtain a feature map F_{B3} of size 40×40×192. Then, the feature map F_{B3} passes through a diverse branch C3K2 module for feature extraction to obtain a feature map F_{B4} of size 40×40×128, the feature map F_{B4} passes through a convolution block for feature extraction to obtain a feature map F_{B5} of size 20×20×128, and the feature map F_{B5} is concatenated with the feature map F₅ to obtain a feature map F_{B6} of size 20×20×384. Finally, the feature map F_{B6} passes through a diverse branch C3K2 module for feature extraction to obtain a feature map F_{B7} of size 20×20×256. The third column passes the feature map F through a DELA module to obtain a feature map F_{C1} of size 80×80×64, passes the feature map F_{B4} through a DELA module to obtain a feature map F_{C2} of size 40×40×128, and passes the feature map F_{B7} through a DELA module to obtain a feature map F_{C3} of size 20×20×256.

The output part includes three detection heads, which take the feature maps F_{C1}, F_{C2}, and F_{C3} as inputs respectively. The feature maps of three different scales are processed to recognize pedestrian targets of different sizes in an image, and the positions, category information, and bounding boxes of the detected targets are displayed in the image.

In step 3, the AD-YOLO-RPBNet model is trained using the dataset obtained in the step 1. The trained AD-YOLO-RPBNet model is used for pedestrian detection of autonomous driving under complex backgrounds.

### Embodiment 3

This embodiment provides a pedestrian detection method for autonomous driving under complex backgrounds, and includes the following steps for achieving automatic obstacle avoidance for autonomous vehicles through pedestrian target detection under complex backgrounds:

### (1) Data Acquisition and Preparation Phase

### 1.1. Data Acquisition

Device: A binocular vehicle-mounted camera is used to capture actual road condition images. Images with simple and complex backgrounds are captured on different streets at different time periods. Images with simple backgrounds mainly include images with complete and clear pedestrian contours, a small number of pedestrians (fewer than five), and different degrees of occlusion. Images with complex backgrounds mainly include cluttered backgrounds, background textures similar to pedestrians, overly dense pedestrians, occluded pedestrian contours, and the like. The binocular vehicle-mounted camera is used to capture images in different urban scenarios with dense pedestrians, such as urban streets, shopping malls, stations, and areas near schools.

The different degrees of occlusion of pedestrian contours are classified as: light occlusion, where the pedestrian occlusion ratio is less than 30%, and key body parts are visible; moderate occlusion, where the pedestrian occlusion ratio is greater than 30% and less than or equal to 60%, and major body structures are partially missing; and heavy occlusion, where the pedestrian occlusion ratio is greater than 60%, leaving only fragmented body features.

In this embodiment, the images are divided into eight categories: simple background with light occlusion, simple background with moderate occlusion, simple background with heavy occlusion, background interference (including cluttered backgrounds and background textures similar to pedestrians), overly dense pedestrians, complex background with light occlusion, complex background with moderate occlusion, and complex background with heavy occlusion.

Operation: For each street scenario, images of pedestrians in traffic conditions are captured to ensure coverage of images under different backgrounds and a plurality of groups of pedestrian target images. For example, in this embodiment, the acquisition target is pedestrian images under different backgrounds on the road. The target is locked, and the target road is captured from different angles using a binocular vehicle-mounted camera. Pedestrian images under different backgrounds and different degrees of occlusion are acquired from the Internet and combined with the captured images to form the dataset used in this embodiment.

### 1.2 Data Processing

Dataset acquisition: The captured image data is preliminarily processed, including removing obvious noise and outliers from the images, and cropping and resizing the images to ensure consistency and standardization of the image dataset. The captured images are divided into a training set and a test set at a ratio of 7:3.

Data augmentation: Data augmentation operations such as rotation, scaling, and flipping (excluding brightness adjustments, and the like) are performed on the training set to improve the robustness and generalization ability of the model.

### 2. Model Training Phase

### 2.1 Model Construction

The AD-YOLO-RPBNet model is constructed, including three parts: backbone, neck, and output. The specific structure is the same as that in Embodiment 1.

### 2.2 AD-YOLO-RPBNet Model Training

At the start of training, network model initialization parameters are first set: A number of epochs for training the network model is set to 650, an optimizer adopts an Adagrad optimizer, an initial learning rate of the Adagrad optimizer is set to 0.01, and a gradient weight decay parameter is set to 5e-2. During training, images in the training set are input into the AD-YOLO-RPBNet model and read according to a storage path of the training set. When the overall network loss function LOWFL no longer shows a significant decrease (within an error of ±1e-4), the network model training is considered stable, and the training process is completed.

Loss function: The occlusion-weighted focal loss is adopted, which assigns occlusion category weights to different degrees of occlusion to improve target detection performance.

During model testing, images in the prepared test set are input, and the network weights obtained after training on the training set are imported to obtain test results, completing the target detection objective of the model.

### 3. Processing and Analysis Phase

### 3.1 Model Deployment

Deployment: In this embodiment, a binocular vehicle-mounted camera module is composed of two cameras: a left camera and a right camera, each with a resolution of 1920×1080, 30 FPS, and a field of view (FOV) (H×V×D) of 72.6°×50°×82° (±3°). The two cameras need to be mounted in parallel, and optical axes are aligned to ensure stereoscopic vision accuracy. The left and right cameras are then calibrated to obtain intrinsic and extrinsic parameters, distortion coefficients, and homography matrices. Based on the calibration results, the two cameras are calibrated such that the images obtained by the calibrated cameras lie on the same plane and are parallel to each other. Then, a disparity map is converted, and the images captured by the two cameras are converted into a depth map through a reprojection matrix to obtain coordinates in three-dimensional space, completing the preparation of the binocular vehicle-mounted camera module.

The trained AD-YOLO-RPBNet model is deployed into an autonomous vehicle for real-time pedestrian detection during driving. The autonomous vehicle travels on urban roads at a speed within 40 km/h. A target detection system on the vehicle performs target detection on real-time pedestrian images on the road transmitted by the binocular vehicle-mounted camera module. After a pedestrian target is recognized, the recognition result is transmitted to a vehicle-pedestrian distance calculation module, which calculates the distance between the vehicle and the recognized pedestrian. Then, a feedback module adjusts a driving state of the vehicle according to different distances.

### 3.2 Result Analysis

Model quality evaluation: The target detection performance is evaluated using mAP, FPS, and the parameter count.

The same loss function is used on the dataset of pedestrian conditions under different backgrounds captured by the same binocular vehicle-mounted camera module (dataset size: 12,000 images). The AD-YOLO-RPBNet model of the present disclosure was compared with existing methods. The comparison results show that compared to YOLOv11, Faster R-CNN, CenterNet, YOLOv8, or models with different DELA module placements from the present disclosure, the target detection method of the present disclosure has lower computational load and better performance. The comparison results obtained from different models after training for pedestrian target detection are shown in Table 1.

TABLE 1
Comparison of different model indicators

| | Dataset of pedestrian condition images | | | |
|---|---|---|---|---|
| | under different backgrounds | | | |
| Model | mAP (%) | FPS | Parameters | |
| AD-YOLO-RPBNet | 77.31 | 90.21 | 18 | million |
| YOLOv11 | 66.8 | 79.51 | 21 | million |
| YOLOv8 | 60.80 | 49.97 | 8 | million |
| CenterNet | 52.92 | 38.17 | 19.4 | million |
| Faster R-CNN | 30.32 | 28.21 | 43.1 | million |
| AD-YOLO-RPBNet | 66.31 | 78.56 | 18 | million |
| model with DELA | | | | |

placed after C2PSA

The results shown in Table 1 indicate that when performing target detection on the dataset of pedestrian condition images under different backgrounds captured by the binocular vehicle-mounted camera module, the AD-YOLO-RPBNet model achieves higher mAP than existing YOLOv11, YOLOv8, CenterNet, and Faster R-CNN, which perform relatively well, and still maintains relatively high FPS while ensuring fewer parameters. Compared to the aforementioned similar target detection methods, the differences are significant, thus demonstrating the superior application performance of the detection method of the present disclosure.

In the present disclosure, the introduction of diverse branch convolutions into the diverse branch C3K2 module further enhances the feature extraction capability of the model, improves detection accuracy, maintains a lightweight design, enhances adaptability, and works synergistically with the DELA module to improve the overall performance of the model, easily handling the above complex situations. In terms of the loss function, the occlusion-weighted focal loss is used, which assigns different occlusion category weights to different degrees of occlusion, forcing the model to pay more attention to the feature learning of occluded samples during training, thereby balancing the contributions of occluded samples and normal samples, specifically addresses the pedestrian occlusion problem under complex backgrounds, and achieves a balance among accuracy, robustness, and efficiency. By combining diverse branch structures, the diverse branch convolution can capture richer feature representations and utilize complex branch structures to enhance feature learning, thus improving the detection accuracy of the model without significantly increasing computational complexity. The introduction of diverse branch convolution enables the model to accurately identify pedestrians under complex backgrounds, especially in urban environments where the background contains a large number of cluttered objects or textures, or where pedestrians have similar colors or textures to the background, as well as situations where moving objects or changing lighting conditions in the background cause instability in the background model.

### Embodiment 4

This embodiment provides a pedestrian detection system for autonomous driving under complex backgrounds, including:

A binocular vehicle-mounted camera module is configured to acquire pedestrian images under different road conditions.

An AD-YOLO-RPBNet model is configured to perform real-time pedestrian target detection during driving.

A vehicle-pedestrian distance calculation module is configured to measure the distance and angle between and speed of the vehicle and the target using a millimeter-wave radar sensor based on a target detection result. By transmitting and receiving millimeter-wave signals, the module measures the distance and angle between the vehicle and the target. The module features high precision, high resolution, and strong anti-interference capability, being suitable for various road and weather conditions.

A feedback module is configured to alert a driver based on a calculation result of the vehicle-pedestrian distance calculation module and to adjust a driving state of the vehicle. The target detection result, the distance between the vehicle and the pedestrian, and a relative position of the target to the vehicle are displayed on a vehicle-mounted screen. The target detection result includes confidence and a degree of occlusion, for example: “a pedestrian detected 10 meters ahead to the right, 60% occluded.” Based on the target detection result and data from the vehicle-pedestrian distance calculation module, the feedback module is triggered. The feedback module determines a hierarchical announcement level according to the calculation result of the vehicle-pedestrian distance calculation module, and issues a hierarchical announcement of instructions such as “watch for pedestrians”, “slow down”, or “emergency brake”.

When the distance to the pedestrian is greater than 15 meters, the risk level is low. The feedback module displays a warning on the vehicle-mounted screen to alert the driver, and simultaneously announces the instruction “watch for pedestrians” by voice.

When the distance to the pedestrian is between 5 and 15 meters, the risk level is moderate. The feedback module displays a warning on the vehicle-mounted screen and announces the instruction “slow down” by voice to alert the driver, while automatically applying light braking and tightening the seatbelt pretensioner.

When the distance to the pedestrian is less than 5 meters, the risk level is high. The feedback module triggers automatic emergency braking, applying maximum braking force, and alerts the driver by announcing the instruction “emergency brake” and displaying a warning on the vehicle-mounted screen.

### Embodiment 5

The AD-YOLO-RPBNet model is applied in traffic flow monitoring, specifically for the detection and counting of pedestrian targets under different backgrounds.

Deployment: The trained AD-YOLO-RPBNet model is deployed into an urban traffic monitoring system for real-time pedestrian flow detection and counting on key road sections.

This embodiment verifies the capability of the AD-YOLO-RPBNet model to detect and count pedestrian targets under different backgrounds, providing a new solution for pedestrian flow monitoring on key urban road sections.

The present disclosure aims to resolve the existing deficiencies in current pedestrian target detection technologies, namely insufficient detection accuracy and slow processing speed under complex backgrounds. Through the AD-YOLO-RPBNet model of the present disclosure, pedestrian target detection under complex backgrounds is achieved, improving recognition efficiency and saving computational resources. The model enables timely distance control through driving feedback from autonomous vehicles, improving driving efficiency.

The technical solution of the present disclosure improves target detection efficiency, avoids the impact of complex backgrounds, and has significant implications for the efficiency and safety of pedestrian target detection in autonomous vehicles.

What is not mentioned in the present disclosure is applicable to the prior art.

What is claimed is:

1. A pedestrian detection method for autonomous driving under complex backgrounds, comprising following steps:
step 1: obtaining a dataset, wherein
a binocular vehicle-mounted camera is used to capture pedestrian images under actual road conditions in shopping malls, stations, and different streets at different time periods, pedestrian images under different urban backgrounds and different degrees of occlusion are acquired from Internet, comprising images with simple backgrounds and complex backgrounds under different degrees of occlusion, and the pedestrian images under the actual road conditions and the pedestrian images under the different urban backgrounds and the different degrees of occlusion together form the dataset; images in the dataset are annotated using LabelImg, to mark pedestrian targets in the images in the dataset, comprising position boxes and category information of the pedestrian targets;
step 2: constructing an Automatic Driving You Only Look Once Respond for Pedestrian Background Influence Object Detection Network (AD-YOLO-RPBNet) model, wherein
a backbone part of the AD-YOLO-RPBNet model comprises four serial structures comprising convolution blocks and diverse branch C3K2 modules; and in a neck part of the AD-YOLO-RPBNet model, one diverse branch C3K2 module is introduced in a first column, three alternating diverse branch C3K2 modules are introduced in a second column, and an output of each diverse branch C3K2 module in the second column is connected to a detection head via a diverse efficient local attention (DELA) module;
each diverse branch C3K2 module comprises a convolution block, from which two branches diverge, and one branch is processed by two diverse branch C3K modules, and then concatenated with the other branch, followed by a 1×1 convolution to generate an output;
each diverse branch C3K module comprises a convolution block and two bottleneck layers that are sequentially connected; and each bottleneck layer comprises two diverse branch convolutions connected in sequence;
each diverse branch convolution comprises five branches, wherein a first branch outputs after a 1×1 convolution and a batch normalization (BN) layer; a second branch outputs after a 1×1 convolution, a BN layer, a 3×3 convolution, and a BN layer in sequence; a third branch outputs after a 1×1 convolution, a BN layer, a max pooling layer, and a BN layer in sequence; a fourth branch outputs after a 3×3 convolution, a BN layer, an average pooling layer, and a BN layer in sequence; a fifth branch outputs after a 3×3 convolution and a BN layer; and finally, outputs of the five branches are concatenated and then processed by a non-linear layer to obtain an output of the diverse branch convolution; and
the DELA module is provided with three branches, wherein two branches respectively use X max pooling and Y average pooling in a spatial dimension to obtain feature vectors in horizontal and vertical directions, the feature vectors respectively pass through a 1×1 convolution, a group normalization (GN) layer, and a sigmoid function to generate attention weights in the horizontal and vertical directions, and feature weighting is performed on the attention weights in the horizontal and vertical directions and an input of the DELA module according to corresponding directions, to obtain an output of the DELA module; and
step 3: training the AD-YOLO-RPBNet model using the dataset obtained in the step 1, wherein the trained AD-YOLO-RPBNet model is used for pedestrian detection of autonomous driving under the complex backgrounds.

2. The pedestrian detection method for autonomous driving under complex backgrounds according to claim 1, wherein the neck part of the AD-YOLO-RPBNet model comprises three columns of structures, wherein the first column is formed by connecting in sequence from bottom to top an upsampling operation, a concatenation operation, a diverse branch C3K2 module, an upsampling operation, and a concatenation operation; the second column is formed by connecting in sequence from top to bottom a diverse branch C3K2 module, a convolution block, a concatenation operation, a diverse branch C3K2 module, a convolution block, a concatenation operation, and a diverse branch C3K2 module; and a third column comprises three parallel DELA modules;
an output of a cross stage partial with pyramid squeeze attention (C2PSA) module in the backbone part is connected to both the upsampling operation at a bottom of the first column of the neck part and the concatenation operation at a bottom of the second column; outputs of the third diverse branch C3K2 module and the second diverse branch C3K2 module in the backbone part are respectively connected to the two concatenation operations in the first column of the neck part; an output of the diverse branch C3K2 module in the first column of the neck part is connected to the concatenation operation at a top of the second column; an output of the concatenation operation at a top of the first column is input into the diverse branch C3K2 module at the top of the second column; and the three diverse branch C3K2 modules in the second column are each connected to one DELA module; and
in an output part of the AD-YOLO-RPBNet model, three feature maps of different scales are processed by three detection heads, so as to recognize pedestrian targets of different sizes in an image, and display category information and bounding boxes of the pedestrian targets detected in the image.

3. The pedestrian detection method for autonomous driving under complex backgrounds according to claim 1, wherein the AD-YOLO-RPBNet model uses an occlusion-weighted focal loss that considers occlusion category weights, as a loss constraint during training the AD-YOLO-RPBNet model.

4. The pedestrian detection method for autonomous driving under complex backgrounds according to claim 1, wherein at start of training the AD-YOLO-RPBNet model, model initialization parameters are set as follows: a number of epochs for the training is set to 650, an optimizer adopts an adaptive gradient descent (Adagrad) optimizer, an initial learning rate of the Adagrad optimizer is set to 0.01, and a gradient weight decay parameter is set to 5e-2; and the training is stopped when a loss variation error is within ±1e-4.

5. The pedestrian detection method for autonomous driving under complex backgrounds according to claim 1, wherein a size of the images in the dataset is 640×640.

6. A pedestrian detection system for autonomous driving under complex backgrounds, executing steps of the pedestrian detection method for autonomous driving under complex backgrounds according to claim 1, and comprising:
a binocular vehicle-mounted camera module configured to acquire pedestrian images under different road conditions;
an Automatic Driving You Only Look Once Respond for Pedestrian Background Influence Object Detection Network (AD-YOLO-RPBNet) model configured to perform real-time pedestrian target detection during autonomous driving;
a vehicle-pedestrian distance calculation module configured to measure a distance and angle between and speed of a vehicle and a target using a millimeter-wave radar sensor based on a target detection result; and
a feedback module configured to alert a driver based on a calculation result of the vehicle-pedestrian distance calculation module and to adjust a driving state of the vehicle.

7. The pedestrian detection system for autonomous driving under complex backgrounds according to claim 6, wherein the target detection result, the distance between the vehicle and the target, and a relative position of the target to the vehicle are displayed on a vehicle-mounted screen, wherein the target detection result comprises a confidence and a degree of occlusion; and
the feedback module is triggered based on the target detection result and data from the vehicle-pedestrian distance calculation module, to determine a hierarchical announcement level according to the calculation result of the vehicle-pedestrian distance calculation module, and issue a hierarchical announcement of a “watch for pedestrians” instruction, a “slow down” instruction, or an “emergency brake” instruction.

8. The pedestrian detection system for autonomous driving under complex backgrounds according to claim 6, wherein the AD-YOLO-RPBNet model is applied to pedestrian target detection in autonomous driving under complex backgrounds, achieving mean average precision (mAP) greater than 70%, frames per second (FPS) greater than 80, and a parameter count between 15 and 20 million.
